(19) United States
(12) Patent Application Publication
(10) Pub. No.: US 2013/0283675 A1
(43) Pub. Date: Oct. 31, 2013

(54) BORON-NITROGEN HETEROCYCLES

(71) Applicants: Shih-Yuan Liu, Eugene, OR (US); Kshitij Parab, Richland, WA (US); Wei Luo, Eugene, OR (US); Patrick Campbell, Eugene, OR (US)

(72) Inventors: Shih-Yuan Liu, Eugene, OR (US); Kshitij Parab, Richland, WA (US); Wei Luo, Eugene, OR (US); Patrick Campbell, Eugene, OR (US)

(73) Assignees: EDUCATION ON BEHALF OF UNIVERSITY OF OREGON, Eugene, OR (US); STATE OF OREGON ACTING BY & THROUGH THE STATE BOARD OF HIGHER

(21) Appl. No.: 13/980,025

(22) PCT Filed: Jan. 25, 2012
(86) PCT No.: PCT/US2012/022596

§ 371 Date: Jul. 16, 2013

Related U.S. Application Data
(60) Provisional application No. 61/437,520, filed on Jan. 28, 2011.
(60) Provisional application No. 61/453,866, filed on Mar. 17, 2011.
(60) Provisional application No. 61/530,956, filed on Sep. 3, 2011.

(51) Int. Cl. C01B 3/00

(52) U.S. Cl. CPC C01B 3/0015
USPC 44/317; 564/10; 564/11

(57) ABSTRACT

A compound having a structure represented by:

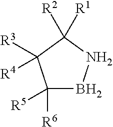

wherein each of R¹ to R⁶ is individually selected from a C₁-C₆ alkyl or H; provided that each of R¹ to R⁶ is H, or at least one of R¹ to R⁶ is methyl.

Also disclosed is a hydrogen storage system that includes the compound.

### CROSS REFERENCE TO RELATED APPLICATION

This application claims the benefit of U.S. Provisional Application No. 61/437,520, filed Jan. 28, 2011, U.S. Provisional Application No. 61/453,866, filed Mar. 17, 2011, and U.S. Provisional Application No. 61/530,956, filed Sep. 3, 2011, all of which are incorporated herein by reference in their entireties.

### ACKNOWLEDGMENT OF GOVERNMENT SUPPORT

This invention was made with government support under EERE-GO18143 awarded by the Department of Energy. The government has certain rights in the invention.

### BACKGROUND

Safe, efficient storage and delivery of hydrogen is essential for the development of a hydrogen-based energy infrastructure. Storage of hydrogen as a compressed gas (up to 10,000 psi/700 bar) is the current state-of-the-art, however, to increase storage density and mitigate the risks associated with storage and transport of high pressure gas, numerous condensed phase hydrogen storage approaches are currently under investigation. These include metal hydrides, sorbent materials, and chemical hydride systems. Boron- and nitrogen-containing chemical hydrides have attracted much attention because of their high gravimetric hydrogen densities and favorable kinetics of hydrogen release. Ammonia borane (H₃N—BH₃, AB), with a gravimetric density of 19.6 wt % H₂, is one of the most promising candidates among the chemical hydride materials. AB has both hydridic and protic hydrogens, facilitating H₂ release under mild conditions. But while the release of H₂ from AB and its derivatives has been extensively investigated, AB is a solid material that releases H₂ at its melting point and cannot serve as liquid fuel without dilution (e.g., with a solvent), which necessarily reduces its hydrogen storage capacity.

The appeal of a safe, liquid-phase hydrogen storage material is clear. The US has a network of over 150,000 miles (244,000 km) of pipeline dedicated to delivering liquid petroleum products, and many nations worldwide have similar networks in place. The transition to a hydrogen-based energy economy will be greatly facilitated if it can take advantage of the existing liquid-based distribution channels such as pipelines, tankers, and retail outlets. Two potential liquid hydrogen storage materials that have received recent attention in the literature are formic acid, HCO₂H, and hyhydrazine, N₂H₄.H₂O. One potential disadvantage of these compounds is that they have decomposition pathways that potentially generate side products toxic to fuel cell catalysts (e.g. CO and NH₃) in addition to potential safety concerns (e.g., for hydrazine). Liquid organic hydrides (i.e., hydrocarbons) are another class of potential hydrogen carriers, but for carbon-rich systems, the hydrogen liberation step is strongly endothermic, typically requiring reaction temperatures of 350-500° C., well above the “waste heat” of 80-90° C. provided by a standard PEM fuel cell. This limitation can be overcome somewhat by the incorporation of heteroatoms into the carbon scaffold. Pez, Scott and Chang of Air Products Corporation have studied the use of 9-ethylcarbazole as a hydrogen storage material and demonstrated dehydrogenation of 9-perhydroethylcarbazole at 150-200° C. in a series of patents. In 2010, Tsang et al. published an elegant method to regenerate spent 9-ethylcarbazole fuel using molecular H2 and an alumina supported ruthenium catalyst. One other drawback to 9-ethylcarbazole hydrogen storage is that the spent fuel material is a solid at temperatures up to 60° C.

The development of a liquid-phase hydrogen storage material has the potential to take advantage of the existing liquid-based distribution infrastructure. A viable liquid-phase hydrogen storage material should be a liquid under ambient conditions (e.g., at 20° C. and 1 atm pressure), be air and moisture stable, be recyclable, release H2 controllably, cleanly, and quantitatively at temperatures below or at the PEM fuel cell waste heat temperature of 80° C., utilize catalysts that are cheap and abundant for H2 desorption, feature reasonable gravimetric and volumetric storage capacity, and not undergo a phase change upon H₂ desorption.

### SUMMARY

Disclosed herein is a compound having a structure represented by:

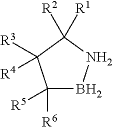

wherein each of R¹ to R⁶ is individually selected from a C₁-C₆ alkyl or H; provided that each of R¹ to R⁶ is H, or at least one of R¹ to R⁶ is methyl.

Also disclosed herein is a compound having a structure represented by:

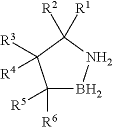

wherein each of R¹ to R⁶ is individually selected from H, a C₁-C₆ alkyl, halogen, a C₁-C₆ alkoxy, a C₁-C₆ alkoxy-substituted C₁-C₆ alkyl, or an amino; provided that neither R⁵ nor R⁶ is an ethyl.

Further disclosed herein is a compound having a structure represented by:

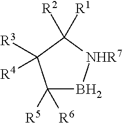

wherein each of R¹ to R⁶ is individually selected from H, a C₁-C₆ alkyl, halogen, a C₁-C₆ alkoxy, a C₁-C₆ alkoxy-substituted C₁-C₆ alkyl, or an amino; and R⁷ is halogen, a C₁-C₆ alkyl, C₁-C₆ acyl, SiR⁸₃ wherein R⁸ is halogen, amino or alkoxy.

A method is also disclosed herein that comprises reacting an N-protected, optionally-substituted allylamine with triethylamine borane to produce a N-substituted, optionally-carbon-substituted boron-nitrogen cyclopentane intermediate that is subsequently deprotected and hydrogenated (via a H₂ equivalent, e.g., H⁺, H⁻) to produce an optionally-carbon-substituted boron-nitrogen (BN) cyclopentane.

Further disclosed herein is a hydrogen storage system comprising a compound having a structure represented by:

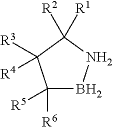

wherein each of R¹ to R⁶ is individually selected from a C₁-C₆ alkyl or H.

Also disclosed herein are methods for releasing hydrogen from any one of the above-described compounds or hydrogen storage systems.

An additional embodiment disclosed herein is a method comprising:

releasing hydrogen from a compound having a structure represented by:

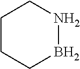

under conditions sufficient to produce at least one boron-nitrogen trimer heterocycle; and

hydrogenating the boron-nitrogen trimeric fused heterocycle.

Also disclosed herein is a hydrogen storage method comprising:

releasing hydrogen from at least one saturated boron-nitrogen monocyclic heterocycle under conditions sufficient to produce at least one boron-nitrogen trimeric fused heterocycle;

and hydrogenating the boron-nitrogen trimeric fused heterocycle.

The foregoing will become more apparent from the following detailed description, which proceeds with reference to the accompanying figures.

### BRIEF DESCRIPTION OF THE DRAWINGS

FIG. 1 is a graph showing the results from an automated burette measurement of H2 release catalyzed by metal chloride complexes.

FIG. 2 is a graph showing the results of large scale dehydrogenation of compound 1 using 5 mol % FeCl₂ without solvent.

FIG. 3 depicts a synthetic scheme and X-ray structures of a chemically and kinetically competent dimer intermediate.

### DETAILED DESCRIPTION

### Terminology

The following explanations of terms and methods are provided to better describe the present compounds, compositions and methods, and to guide those of ordinary skill in the art in the practice of the present disclosure. It is also to be understood that the terminology used in the disclosure is for the purpose of describing particular embodiments and examples only and is not intended to be limiting.

“Acyl” refers to a group having the structure R(O)C—, where R may be alkyl, or substituted alkyl. “Lower acyl” groups are those that contain one to six carbon atoms.

The term “alkoxy” refers to a straight, branched or cyclic hydrocarbon configuration that include an oxygen atom at the point of attachment. An example of an “alkoxy group” is represented by the formula —OR, where R can be an alkyl group. Suitable alkoxy groups include methoxy, ethoxy, n-propoxy, i-propoxy, n-butoxy, i-butoxy, sec-butoxy, tert-butoxy cyclopropoxy, cyclohexyloxy, and the like.

The term “alkyl” refers to a branched or unbranched saturated hydrocarbon group, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like.

The term “halogen” refers to fluoro, bromo, chloro and iodo substituents.

The term “amino” refers to a group of the formula —NRR′, where R and R′ can be, each independently, hydrogen or a C₁-C₆ alkyl.

### Compounds

Disclosed herein are boron-nitrogen (BN) cyclopentanes that are useful as hydrogen storage materials.

In particular, disclosed herein in one embodiment is a compound having a structure represented by:

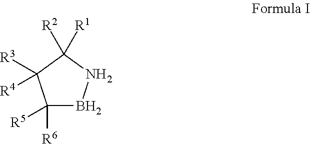

wherein each of R¹ to R⁶ is individually selected from a C₁-C₆ alkyl or H. In certain embodiments, at least one of R¹ to R⁶ is a methyl. In particular embodiments of Formula I, only one of R¹ to R⁶ is a methyl, and the other R¹ to R⁶ substituents are preferably, but not necessarily, H. In other embodiments of Formula I at least two or three of R¹ to R⁶ is a methyl, and the other R¹ to R⁶ substituents are preferably, but not necessarily, H. For example, R¹ and R³ are each methyl; R³ and R⁵ are each methyl; R¹ and R⁵ are each methyl; or R¹, R³ and R⁵ are each methyl. In certain embodiments of Formula I neither R⁵ nor R⁶ is an ethyl.

In certain embodiments the compound is selected from:

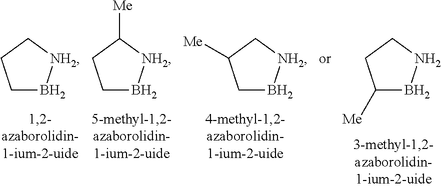

Also disclosed herein is an embodiment of a compound having a structure represented by:

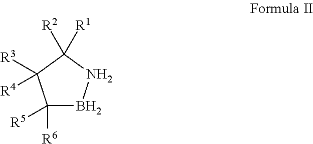

wherein each of R¹ to R⁶ is individually selected from H, a C₁-C₆ alkyl, halogen, a C₁-C₆ alkoxy, a C₁-C₆ alkoxy-substituted C₁-C₆ alkyl, or an amino; provided that neither R⁵ nor R⁶ is an ethyl. A particularly preferred halogen is F due to its light weight and the strong C—F bond.

Also disclosed herein is a further embodiment of a compound having a structure represented by:

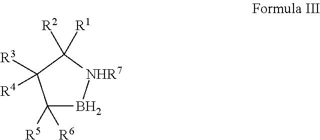

wherein each of R¹ to R⁶ is individually selected from H, a C₁-C₆ alkyl, halogen, a C₁-C₆ alkoxy, a C₁-C₆ alkoxy-substituted C₁-C₆ alkyl, or an amino; and R⁷ is halogen, a C₁-C₆ alkyl, C₁-C₆ acyl, SiR⁸₃ wherein R⁸ is halogen, amino or alkoxy (particularly C₁-C₆ alkoxy). In certain embodiments, R⁷ is particularly methyl, propyl or butyl. In certain embodiments of Formula III, at least one of at least one of R¹ to R⁶ is a methyl. In particular embodiments of Formula III, only one of R¹ to R⁶ is a methyl, and the other R¹ to R⁶ substituents are preferably, but not necessarily, H. In other embodiments of Formula III at least two or three of R¹ to R⁶ is a methyl, and the other R¹ to R⁶ substituents are preferably, but not necessarily, H. For example, R¹ and R³ are each methyl; R³ and R⁵ are each methyl; R¹ and R⁵ are each methyl; or R¹, R³ and R⁵ are each methyl.

It should be appreciated, however, that careful selection of ring substituents may be used to customize or fine-tune the chemical nature of the BN cyclopentane compounds. For example alkyl substitution may create substrates with enhanced organic solubilities, while charged side chains will result in more polar compounds. Additionally, the electron-donating or withdrawing nature of a given substituent or substituents may influence the reactivity of a given substrate to hydrogenation, or the facility with which that substrate can be regenerated.

In certain embodiments, the BN cyclopentane compound has a melting point of less than 55° C. at 1 atmosphere, particularly less than 35° C. at 1 atmosphere, and more particularly less than 0° C. at 1 atmosphere, and most particularly less than −10° C. at 1 atmosphere. The compound may be a liquid at ambient conditions (e.g., 20° C. at 1 atmosphere). The compound may have a gravimetric density of at least 4.0 wt %, more particularly at least 4.5 wt %, and a volumetric density of at least 35 g H₂/L, more particularly at least 40 g H₂/L. In certain embodiments, the compound is air and moisture stable (i.e., the compound does not decompose when handled in air and in the presence of moisture), recyclable (e.g., amenable to rehydrogenation), release H₂ controllably and cleanly such that no significant by-product formation is observed, and preferably quantitatively (e.g., the yield of the desired product is greater than 98%) at temperatures below or at the PEM fuel cell waste heat temperature of 80° C., utilize catalysts that are cheap and abundant for H₂ desorption, feature reasonable gravimetric and volumetric storage capacity, and not undergo a phase change upon H2 desorption.

Another aspect of the compounds-disclosed herein are shorter, simpler routes for the synthesis of the completely charged (i.e, hydrogen-saturated) compounds via a hydroboration-cyclization-hydrogenation sequence. The compounds of Formulae I or II may be synthesized as shown below in scheme I, wherein R⁸, R⁹ and R¹⁰ equate to groups R¹ to R⁶ of Formulae I or II. For example, at least one of R⁸, R⁹ or R¹⁰ may be a C₁-C₆ alkyl such as a methyl. In general, a N-protected (e.g., with a trimethylsilyl (TMS)), optionally-substituted allylamine is reacted with triethylamine borane to produce a N-substituted, optionally-carbon-substituted boron-nitrogen cyclopentane intermediate that is subsequently deprotected and hydrogenated (via a H₂ equivalent, e.g., H⁺, H⁻) to produce the resulting optionally-carbon-substituted BN cyclopentane.

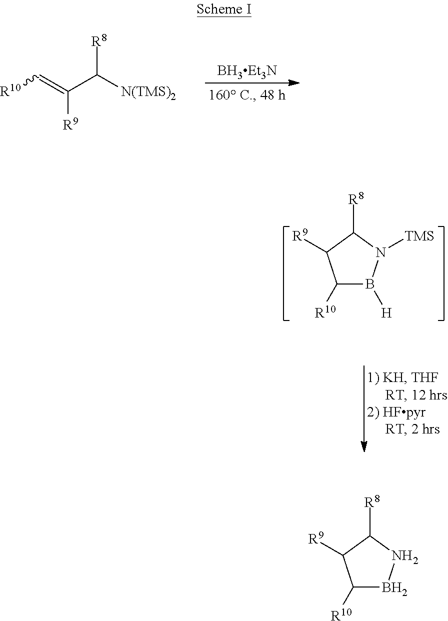

The compound of formula III may be synthesized by scheme II as shown below:

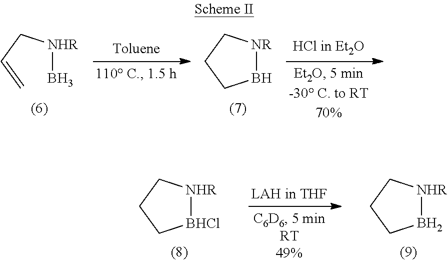

According to scheme II, an N—R-substituted allylamine-borane (6) is heated to produce a heterocyclic intermediate (7). Intermediate (7) is protonated with HCl to form a further intermediate (8) wherein the B position is subsequently reduced with a hydride source (e.g., lithium aluminum hydride) to produce a N—R-substituted BN cyclopentane.

### Hydrogen Storage

The compounds disclosed herein are useful as hydrogen storage materials. In further embodiments disclosed herein, there are provided methods for storing and/or releasing hydrogen from the compounds described herein. For example, disclosed herein are hydrogen storage methods that include releasing hydrogen from at least one saturated boron-nitrogen monocyclic heterocycle under conditions sufficient to produce at least one boron-nitrogen trimeric fused heterocycle, and optionally hydrogenating the boron-nitrogen trimeric fused heterocycle. The hydrogen may be released and/or added during the hydrogen storage cycle in any form. For example, the hydrogen may be released and/or added as a formal equivalent of dihydrogen. A formal equivalent of dihydrogen is two hydrogen atoms, whether the hydrogen atoms are added to the substrate as dihydrogen (during hydrogenation), as hydride ions, or as protons. For example, the combination of a hydride ion and a proton formally constitutes one equivalent of dihydrogen.

The presently disclosed BN cyclopentanes are well-suited to acting as substrates for hydrogen storage: They possess well-defined molecular structure throughout the entire hydrogen storage lifecycle, they possess a high H₂ storage capacity; they exhibit an appropriate enthalpy of H₂ desorption that permits ready regeneration by H₂; and they are either liquids, or are capable of being dissolved in liquids under the desired operating conditions. In addition, the hydrogenation of the subject compounds is readily reversible, regenerating the well-characterized original substrate.

A hydrogen storage cycle for an exemplary BN cyclopentane compound 1 is shown in Scheme VIII below. The cycle depicts the loss of dihydrogen equivalents from the fully charged, i.e. reduced, compound 1. Treatment of compound 2 with a digestion agent followed by a reducing agent regenerates compound 1.

Release of hydrogen from the compounds disclosed herein may be accomplished by several approaches. For example, the compounds are capable of releasing hydrogen both thermally and/or catalytically. Thermal release includes heating the compound at a sufficiently high temperature to affect release of at least one dihydrogen equivalent. For instance, the compound may be heated at a temperature of at least 50° C., particularly at least 150° C. Catalytic release of hydrogen includes contacting the compound with a metal halide catalyst at conditions sufficient for causing hydrogen release. The catalytic dehydrogenation optionally is conducted with heating such as at a temperature from 50 to 200° C., more particularly 50 to 80° C. The metal species of the metal halide catalyst may be selected, for example, from a transition metal, particularly a first-row transition metal. Illustrative metals include iron, cobalt, copper, nickel and illustrative halides include fluorine, chlorine, bromine, and iodine.

The fully-dehydrogenated product is a boron-nitrogen trimeric fused heterocycle. In certain embodiments, the boron-nitrogen trimeric fused heterocycle has a structure of:

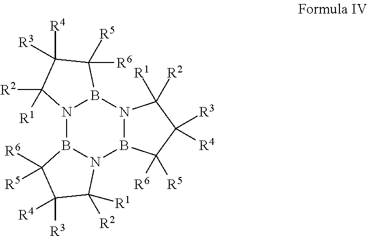

wherein each of R¹ to R⁶ is individually selected from H, a C₁-C₆ alkyl, halogen, a C₁-C₆ alkoxy, a C₁-C₆ alkoxy-substituted C₁-C₆ alkyl, or an amino. The structure of R¹ to R⁶ is dependent upon the structure of the fully-charged (i.e., saturated) compound. For example, if the fully-charged compound is

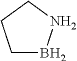

then each of R¹ to R⁶ in the fully-dehydrogenated trimer is H. If the fully-charged compound is one of 3-, 4-, or 5-methyl boron-nitrogen cyclopentane analogs, then the corresponding R¹, R³ or R⁵ group in the fully-dehydrogenated trimer is methyl. The dehydrogenation product may be exclusively the trimer of formula IV or it may be a mixture of trimer IV and at least one partially-dehydrogenated product. In certain embodiments, the trimers are a liquid at 20° C. at 1 atmosphere, and can remain in the liquid phase throughout the hydrogen storage cycle. In one embodiment, the trimer resulting from the 3-methyl BN cyclopentane is a colorless liquid at room temperature with a boiling point of 93° C. at 0.16 torr, and a melting point of 9° C.

The dehydrogenated product(s) may be regenerated by hydrogenating (i.e., reducing) the dehydrogenated product(s). The dehydrogenated product(s) are also referred to herein as “spent fuel.” An illustrative regeneration embodiment is shown below in scheme III. Scheme III is shown for a 1,2-azaborine charged fuel compound 1, but this regeneration approach may also be applicable to BN cyclopentanes. The dehydrogenated product(s) T is subjected to alkanolysis (e.g., methanolysis) to produce an intermediate. The intermediate then is reduced to the fully-charged fuel 1 by reaction with a reducing agent such as LiAlH₄, BH₃, or any other metal hydride MHₓ wherein M is an alkali or earth alkali metal or any transition metal and x can be any number of hydrogens.

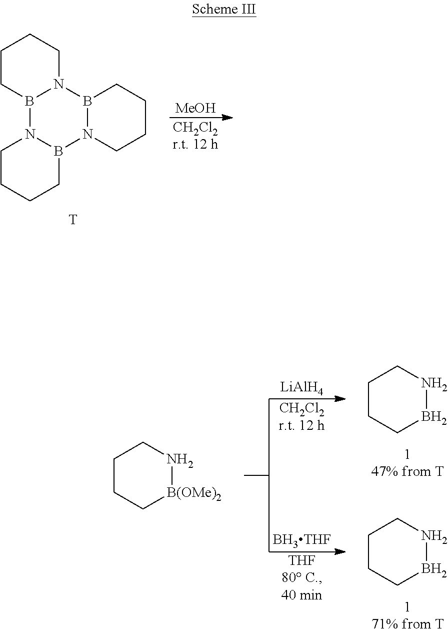

Another illustrative regeneration embodiment is shown below in Scheme IV. Scheme IV is shown for a 1,2-azaborine charged fuel, but this regeneration approach may also be applicable to BN cyclopentanes. The dehydrogenated product(s) T is reacted with a digestion agent that disassembles the trimeric structure. Illustrative digestion agents include carboxylic acids (e.g., formic acid), alcohols, thiols, and inorganic acids (e.g., hydrochloric acid). The reaction with the digestion agent may be facilitated by heating. In the example shown in Scheme IV, treatment of the dehydrogenated product T with formic acid results in formation of the formate adduct. The formate adduct is converted to the fully-charged fuel with release of CO₂, potentially using metal catalysis. The CO₂ can then be captured and reused in combination with molecular hydrogen to generate formic acid to start the regeneration cycle. In a further embodiment, the formate adduct intermediate could be reacted with BH₃ to regenerate the fully-charged fuel and produce B(formate)₃ as a byproduct. The B(formate)₃ can be decomposed to obtain BH₃ and 3CO₂.

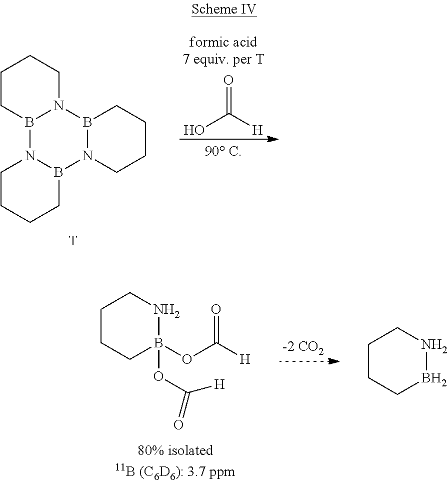

In other embodiments, the hydrogenation may occur in the presence of a hydrogenation catalyst. The hydrogenation catalyst may be a homogeneous catalyst or a heterogeneous catalyst. The hydrogenation catalyst may include one or more platinum group metals, including for example platinum, palladium, rhodium (such as Wilkinson's catalyst), ruthenium, iridium (such as Crabtree's catalyst), or nickel (such as Raney nickel or Urushibara nickel). Alternatively, or in addition, the hydrogenation may include reducing the BN cyclopentane compound with a source of hydride. The hydride typically formally adds to the ring boron atom of the BN cyclopentane compound. When used in combination, the compound may first be hydrogenated to yield a saturated intermediate, and the saturated intermediate then reacts with hydride. Alternatively, or in addition, the hydrogenation may include protonation of the ring nitrogen atom of the BN cyclopentane compound. In one aspect of the method, protonation occurs at a saturated intermediate anion.

The hydrogen storage system may include at least one of the compounds described above. Where the disclosed compounds are used in a hydrogen storage system, the compounds are typically present in a liquid phase, such as dissolved in a suitable organic solvent. The hydrogen storage device and/or liquid phase may include one or more catalysts, solvents, salts, clathrates, crown ethers, carcarands, acids, and bases. The hydrogen storage system may include a port for the introduction of hydrogen for subsequent storage. Similarly, it may include a tap or port for the collection of regenerated hydrogen gas.

Such a hydrogen storage system may be incorporated into a portable power cell, or may be installed in conjunction with a hydrogen-burning engine. The hydrogen storage system may be used in or with a hydrogen-powered vehicle, such as an automobile. Alternatively, the hydrogen storage device may be installed in or near a residence, as part of a single-home or multi-home hydrogen-based power generation system. Larger versions of the hydrogen storage device may be used in conjunction with, or in replacements for, conventional power generating stations.

The hydrogen storage system may also utilize one or more additional methods of hydrogen storage in combination with the presently disclosed compounds, including storage via compressed hydrogen, liquid hydrogen, and/or slush hydrogen. Alternatively, or in addition, the hydrogen storage system may include alternative methods of chemical storage, such as via metal hydrides, carbohydrates, ammonia, amine borane complexes, formic acid, ionic liquids, phosphonium borate, or carbonite substances, among others. Alternatively, or in addition, the hydrogen storage system may include methods of physical storage, such as via carbon nanotubes, metal-organic frameworks, clathrate hydrates, doped polymers, glass capillary arrays, glass microspheres, or keratine, among others.

In certain embodiments, at least one of the compounds disclosed herein may be included as an additive in a liquid composition that includes at least one further additive in addition to the compound(s) disclosed herein. Preferably, the composition is a liquid at a temperature of 20° C. at 1 atmosphere. In other embodiments, the composition is a liquid at a temperature of −20° C. to 50° C., more particularly −15° C. to 40° C., at 1 atmosphere.

An illustrative liquid composition includes at least one compound disclosed herein and at least further fuel additive, particularly a further H₂ fuel additive. For example, the composition may be a fuel blend that includes the compound disclosed herein as a solvent for a higher H₂-capacity fuel additive (e.g., ammonia borane). In such an embodiment, certain embodiments of the presently disclosed compound (e.g., the methyl-substituted compounds described herein) have a relatively high boiling point due to their polar zwitterionic nature. Such compounds can serve as an ionic liquid solvent for polar hydrogen storage compounds such as ammonia borane (NH₃—BH₃, 19.6 wt %), methylamine borane (MeNH₂—BH₃), or R²⁰NH₂—BH₂R²¹ wherein R²⁰ and R²¹ are each individually a C₁-C₆ alkyl. Consequently, the liquid fuel composition may exceed 10 wt % H while maintaining a liquid phase.

Illustrative embodiments are also described below with reference to the following numbered paragraphs:

1. A compound having a structure represented by:

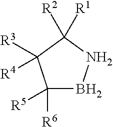

wherein each of R¹ to R⁶ is individually selected from a C₁-C₆ alkyl or H.

2. The compound of paragraph 1, wherein the compound is:

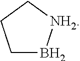

3. The compound of paragraph 1, wherein at least one of R¹-R⁶ is methyl.

4. The compound of paragraph 1, wherein only one of R¹ to R⁶ is a C₁-C₆ alkyl.

5. A hydrogen storage system comprising a compound of any one of paragraphs 1 to 4.

6. The hydrogen storage system of claim 5, further comprising a structure configured to hold the compound of any one of paragraphs 1 to 4.

7. A method comprising releasing hydrogen from any one of the compounds of paragraphs 1 to 4.

8. The method of paragraph 7, wherein releasing hydrogen comprises releasing one or more equivalents of dihydrogen from any one of the compounds of paragraphs 1 to 4.

9. The method of paragraphs 7 or 8, wherein releasing hydrogen comprises producing at least one boron-nitrogen trimeric fused heterocycle.

10. The method of paragraph 9, wherein releasing hydrogen comprises producing a compound having a structure represented by:

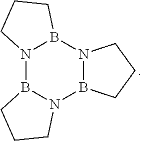 [SMILES: C1CB2N(C1)B1CCCN1B1CCCN21]

11. The method of paragraph 9, further comprising hydrogenating the boron-nitrogen trimeric fused heterocycle.

12. A method comprising:

releasing hydrogen from a compound having a structure represented by:

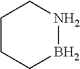

under conditions sufficient to produce at least one boron-nitrogen trimer heterocycle; and

hydrogenating the boron-nitrogen trimeric fused heterocycle.

13. A hydrogen storage method comprising:

releasing hydrogen from at least one saturated boron-nitrogen monocyclic heterocycle under conditions sufficient to produce at least one boron-nitrogen trimeric fused heterocycle;

and hydrogenating the boron-nitrogen trimeric fused heterocycle.

### EXAMPLES

### Example 1

### 1,2-azaborolidin-1-ium-2-uide

In a select embodiment there is disclosed a novel saturated boron-nitrogen monocyclic heterocycle (compound 2) as described in more detail below.

### Experimental Procedure for Synthesis of BN Cyclopentane 2.

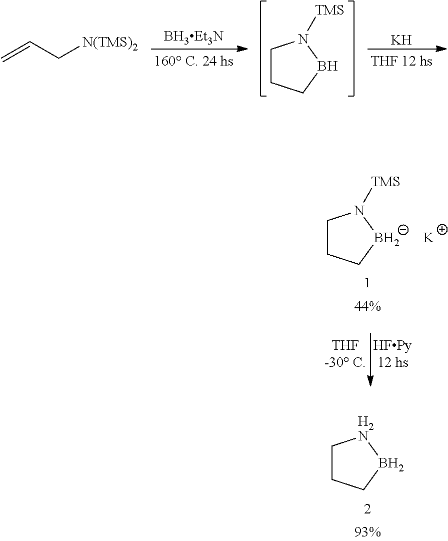

### Compound 1

In a pressure tube, triethylamine borane (15.0 ml, 100 mmol) was added dropwise via syringe to N,N-bis(trimethylsilyl)allylamine (20.0 g, 100 mmol) at room temperature. The solution was allowed to stir for 24 hours at 160° C. At the conclusion of the reaction, the solution was allowed to cool to room temperature. THF (120 ml) was added to the mixture, followed by solid KH (4.00 g, 100 mmol). After stirring the mixture for 12 hours at room temperature, the crude slurry was passed through an Acrodisc. The solvent was removed under reduced pressure, then 150 ml pentane was added. The resulting precipitate was washed with cold pentane. Removal of residual solvent under high vacuum gave 1 as a white solid (8.50 g, 47%). ¹H NMR (300 MHz, THF-d₈): δ 2.72 (t, J=6.0 Hz, 2H), 1.92 (t, J_{BH}=81 Hz, 2H), 1.41 (m, 2H), 0.35 (m, 2H), −0.09 (s, 9H). ¹³C NMR (150 MHz, THF-d₈): δ 49.62, 30.17, 17.30 (br), −0.57. ¹¹B NMR (96 MHz, THF-d₈): δ 12.38 (t, ¹J_{BH}=82.8 Hz).

### Compound 2

An HF.Pyridine solution (1.0 M in THF, 6.0 ml, 6.0 mmol) was added dropwise to a solution containing 1 (0.540 g 3.00 mmol in 8.0 ml THF) at −30° C. The reaction mixture was kept at −30° C. for 12 hours with occasional stirring. At the conclusion of the reaction, the solution was allowed to warm up to room temperature. The mixture was passed though an Acrodisc and concentrated under vacuum gave 2 as a white solid (0.20 g, 92.4%). ¹H NMR (600 MHz, C₆D₆): δ 2.13-2.61 (br, m, 4H), 1.88 (m, 2H), 1.46 (m, 2H), 1.03 (m, 2H). ¹³C NMR (150 MHz, C₆D₆): δ 45.66, 26.20, 12.66 (br). ¹¹B NMR (96 MHz, C₆D₆): δ −13.64 (t, ¹J_{BH}=97.3 Hz).

Due to its low molecular weight, compound 2 possesses several advantages over the analogous six-membered compound A (compound A is described below) as hydrogen storage materials:
1) The melting point of compound 2 is 37° C., much lower than that of compound A, bringing it closer to the desirable liquid state at ambient conditions. Substitution at the carbon positions on the ring of compound 2 may lead to a completely liquid system under ambient conditions.
2) The molecular weight of compound 2 is lower. The lighter weight allows for higher storage capacity compared to compound A.
3) Compound 2 exhibits much higher solubility in certain liquid continuous mediums compared to A, which facilitates its formulation as a liquid fuel.

It has also been determined that the H₂ release for compound 2 is comparatively faster than that of compound A under the thermal conditions shown below:

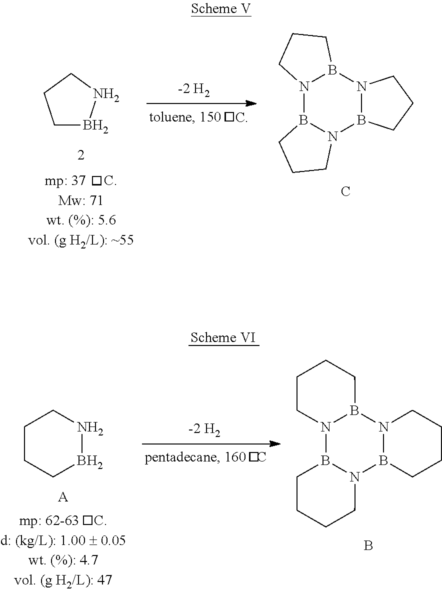

As shown in Schemes V and VI above, saturated boron-nitrogen monocyclic heterocycles (compounds 2 and A) may release hydrogen under certain conditions (e.g., heating) to produce a boron-nitrogen trimeric fused heterocycle (compounds C and B, respectively). The boron-nitrogen trimeric fused heterocycle may then be hydrogenated to complete the hydrogen release/regeneration cycle. In certain embodiments, the hydrogen release may involve releasing one or more equivalents of dihydrogen. A formal equivalent of dihydrogen is two hydrogen atoms, whether the hydrogen atoms are present as H₂, as hydride ions, or as protons. For example, the combination of a hydride ion and a proton formally constitutes one equivalent of dihydrogen.

In a further embodiment disclosed herein there is provided a hydrogen storage material comprising compound 2 that features: 1) High H₂ storage capacity that has the potential to meet U.S. Department of Energy targets (storage material containing least 5.5 wt. % H and at least 40 g H₂ storage potential/L of material), 2) a well-defined molecular structure along the dehydrogenation sequence from the fully charged fuel to the spent fuel, 3) no formation of ammonia and borazine (B₃N₃H₆) that can poison a fuel cell. The indicated hydrogen storage capacities are those predicted at “ambient” conditions (e.g., not cryogenic, not under a pressure greater than atmospheric pressure). Compound 2 has been determined to be thermally stable up to its melting point. Compound 2 is also stable in air and water, thus making it easy to handle, in contrast to pure H₂ gas.

### Example 2

### Methyl Analogs

Also disclosed herein are compounds 3a-3c as hydrogen storage materials. These compounds will exhibit slightly lower storage capacity compared to compound 2, however, they are predicted to be liquids at ambient conditions without the use of solubilizing additives, which will greatly enhance their utility. A liquid fuel at ambient conditions can take advantage of existing fueling infrastructure. It has already been established that compound 2 can be synthesized from bistrimethylsilylallylamine and BH₃.Et₃N complex. Thus, compounds 3a-3c could be made from the corresponding substituted allylamine precursors 4a-4-c with

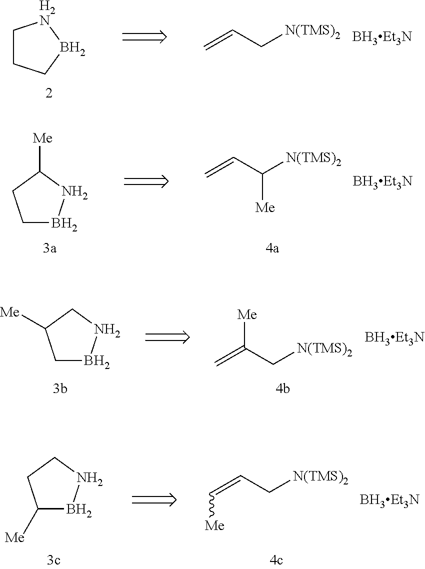

BH₃.Et₃N as shown below.

Also disclosed herein is the development of BNmethylcyclopentane, 1 (Scheme VII), which is a liquid at room temperature. Compound 1 is capable of releasing two equivalents of H₂ per molecule of 1 (4.7 wt. %) both thermally, at temperatures above 150° C., and catalytically using a variety of cheap and abundant metal-halides, at temperatures below 80° C. The exclusive product of dehydrogenation is the trimer, 2, which remains a liquid at room temperature. Conversion of the spent fuel 2 back to the charged fuel 1 can be accomplished in high yield under relatively mild conditions, making this system a potential candidate for liquid-phase hydrogen storage in mobile and carrier applications. In particular, disclosed herein is a single-component liquid-phase H₂ storage material (at 20° C. and 1 atm) has been developed that controllably and quantitatively releases H₂ (4.7 wt. %, 42 g H₂/L) at 80° C. (PEM fuel cell waste heat temperature) without undergoing a phase change using the cheap and abundant FeCl₂ catalyst.

The synthesis of 1 is illustrated in Scheme VII. Treatment of the bis-N-protected amine 3 with neat BH₃.Et₃N at 160° C. for 48 hours generated heterocycle 4, which was not isolated. The crude mixture was diluted with THF followed by addition of KH and HF.pyridine to generate charged fuel 1. The product was purified by column chromatography under ambient conditions (i.e., in the presence of oxygen and moisture), and 1 was isolated in 51% overall yield from 3. Compound 1 is a liquid at room temperature with a melting point of −18° C. We were able to grow crystals of 1 at cold temperatures that were suitable for single crystal X-ray diffraction analysis, thus unambiguously confirming our structural assignment.

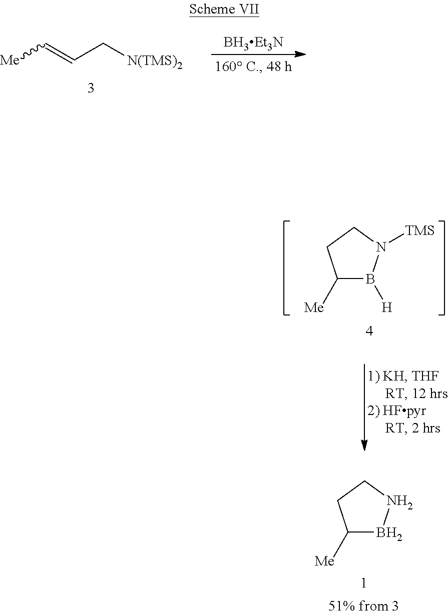

It was determined that heterocycle 1 is thermally stable at 35° C. as a neat liquid.

However, upon heating at 150° C. for 1 hour in the absence of solvent, 1 releases 2 equiv. H₂ to form the trimer 2 (eq 1), which is also a liquid at room temperature (mp: 9° C.). Thus, the hydrogen desorption from charged fuel 1 to form the spent fuel material 2 does not involve a phase change, a beneficial property for a liquid-phase H₂ carrier in terms of actual application in fuel cells.

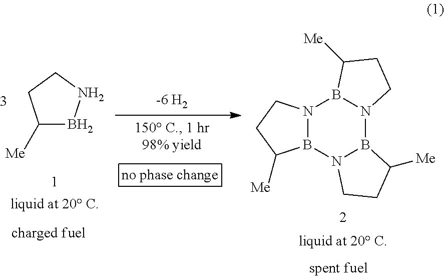

Metal-catalyzed dehydrogenation of AB has attracted growing attention from the perspective of hydrogen storage. Although many important advances have been made with Pd, Ru, Ir and other noble metal catalysts, the development of convenient-to-handle, cheap, abundant, and efficient catalysts with low toxicity is of considerable interest. The work disclosed herein focused on first-row transition metal-halide catalysts. Ramachandran and coworkers reported the use of NiCl₂ and CoCl₂ as catalysts for methanolysis of AB, and Jagirdar et al. used CoCl₂, NiCl₂ and CuCl₂ as reactants assisting the hydrolysis of AB. The use of iron halide salts for AB dehydrogenation has not been reported.

In order to find the most effective metal-halide catalyst for the dehydrogenation of 1, F, Cl, Br, and I complexes of Fe, Co, Ni, and Cu were screened at 5 mol % catalyst loading in toluene. Reaction progress was monitored by ¹¹B NMR. The postulated intermediate 5 is visible via ¹¹B NMR (96 MHz, toluene, 3.0 ppm, doublet, ¹J_{BH}=117 Hz) but could not be isolated for this particular system. The conversions after 5 minutes at 80° C. are listed in Table 1. It was found that, generally, bromide complexes are the most reactive toward formation of 2 (entries 1, 5, 8, 13, 17, and 20), followed by chloride (entries 2, 6, 9, 14, 18, and 21) then iodide (entries 3, 10, 15, and 22) complexes, and that fluoride complexes are almost completely inactive (entries 4, 7, 11, 12, 16, and 19). Copper, nickel and cobalt halides are more reactive than iron (e.g., entries 17, 13, 8 vs. entry 1). The two most active catalysts in this study are NiBr₂ (entry 13) and CuBr (entry 20) which both achieved 76% conversion to 2 in 5 minutes. All the selected chloride, bromide and iodide complexes can completely dehydrogenate 1 to release 2 equivalents of H₂ (per molecule 1) in less than 30 minutes. The presence of a catalyst is essential for H₂ desorption at 80° C. No H₂ release was observed after 1 hour at 80° C. without a catalyst (entry 23).

TABLE 1
Catalyst Optimization Survey for H₂ Desorption of 1.

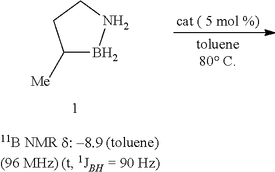

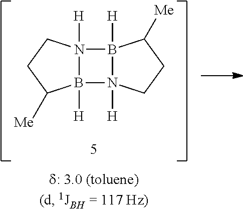

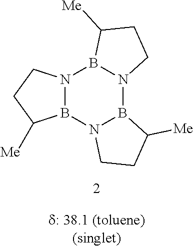 [SMILES: CC1CCN2B1N1CCC(C)B1N1CCC(C)B21]

| | | % B observed for 1, 5, and 2 at 5 min^{a} | | |
|---|---|---|---|---|
| entry | catalyst | 1 | 5 | 2 |
| 1 | FeBr₂ | 8 | 37 | 42 |
| 2 | FeCl₂ | 7 | 33 | 25 |
| 3 | FeI₂ | 10 | 35 | 4 |
| 4 | FeF₂^{b} | 100 | 0 | 0 |
| 5 | FeBr₃ | 9 | 28 | 41 |
| 6 | FeCl₃ | 40 | 37 | 3 |
| 7 | FeF₃^{b} | 100 | 0 | 0 |
| 8 | CoBr₂ | 4 | 32 | 57 |
| 9 | CoCl₂ | 6 | 28 | 43 |
| 10 | CoI₂ | 89 | 11 | 0 |
| 11 | CoF₂^{b} | 100 | 0 | 0 |
| 12 | CoF₃^{b} | 100 | 0 | 0 |
| 13 | NiBr₂ | 8 | 16 | 76 |
| 14 | NiCl₂ | 4 | 27 | 50 |
| 15 | NiI₂ | 3 | 34 | 23 |
| 16 | NiF₂^{b} | 100 | 0 | 0 |
| 17 | CuBr₂ | 8 | 14 | 71 |
| 18 | CuCl₂ | 7 | 33 | 38 |
| 19 | CuF₂^{b} | 100 | 0 | 0 |
| 20 | CuBr | 14 | 9 | 76 |
| 21 | CuCl | 7 | 28 | 45 |
| 22 | CuI | 85 | 15 | 0 |
| 23 | no catalyst^{b} | 100 | 0 | 0 |

^{a}Determined by integration of ¹¹B{¹H} NMR spectrum, average of two runs.
Sums less than 100% are due to the formation of unidentified intermediates that ultimately convert to 2.
^{b}No reaction observed after 1 hour at 80° C.

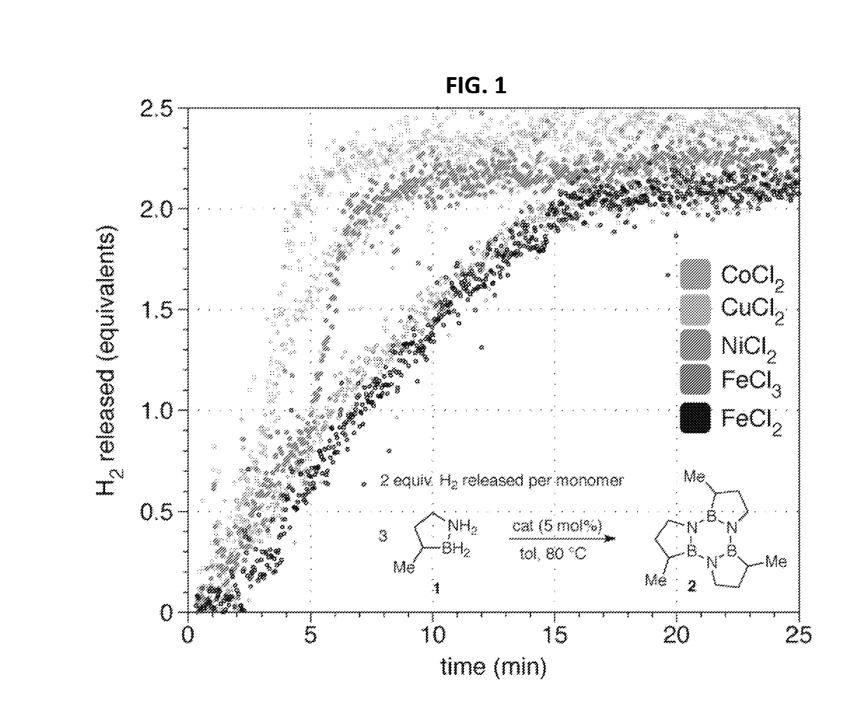

To further understand the differences between various iron-, cobalt-, nickel- and copper-chloride complexes, several dehydrogenation experiments using an automated gas burette apparatus were performed. Chloride complexes were chosen for this study because they are significantly cheaper than bromide complexes. In a general procedure, 75 mg of compound 1 was dissolved in toluene with 5 mol % catalyst, and submerged the reaction flask in an 80° C. oil bath. As can be seen from FIG. 1, varying the metal results in markedly different hydrogen release profiles. CoCl₂ promoted the release of 2 equivalents of H₂ from 1 in ca. 7 minutes, and the CuCl₂- and NiCl₂-catalyzed reactions were complete in under 10 minutes. The iron complexes were slower; both FeCl₃ and FeCl₂ promoted the desorption of 2 equivalents H₂ in ca. 15 minutes. Interestingly, for the cobalt- and nickel-catalyzed reactions, the initial rate of H₂ desorption (i.e., from time zero to the 1.0 equiv. H₂ mark) is apparently slower than the rate from the 1.0 equiv. H₂ mark to the 2.0 equiv. H₂ mark. The automated burette measurement experiments illustrated in FIG. 1 at 50° C. were repeated and it was noted that complete H₂ desorption exceeded 4 hours for all catalysts. This suggests that the reaction temperature plays a significant role on the rate of dehydrogenation.

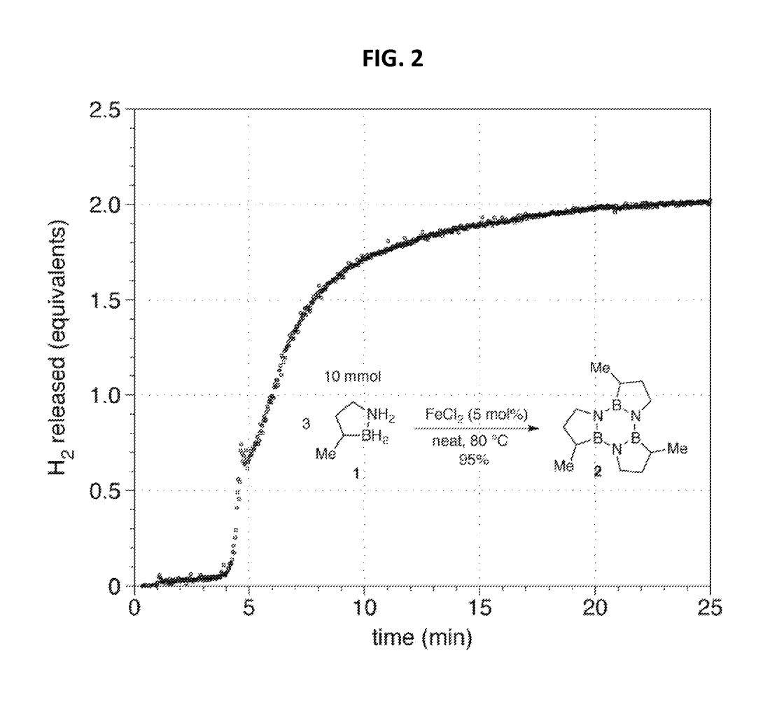

Cost is one of the most important factors that will influence the mass-adoption of a hydrogen storage platform. To demonstrate the potential utility of our material as a simple-to-operate, low cost, single-component liquid system, a large-scale dehydrogenation of 1 (10 mmol, the maximum capacity of our burette apparatus) without additional solvent, using 5 mol % FeCl₂ as a catalyst (ca. $0.30 kg⁻¹), was performed. FIG. 2 shows that 2 equivalents of H₂ are released from the neat material in about 20 minutes at 80° C. At the conclusion of the reaction, spent fuel product 2 was isolated in 95% yield. Noteworthy is the induction period of ca. 4 minutes before significant H₂ release was observed.

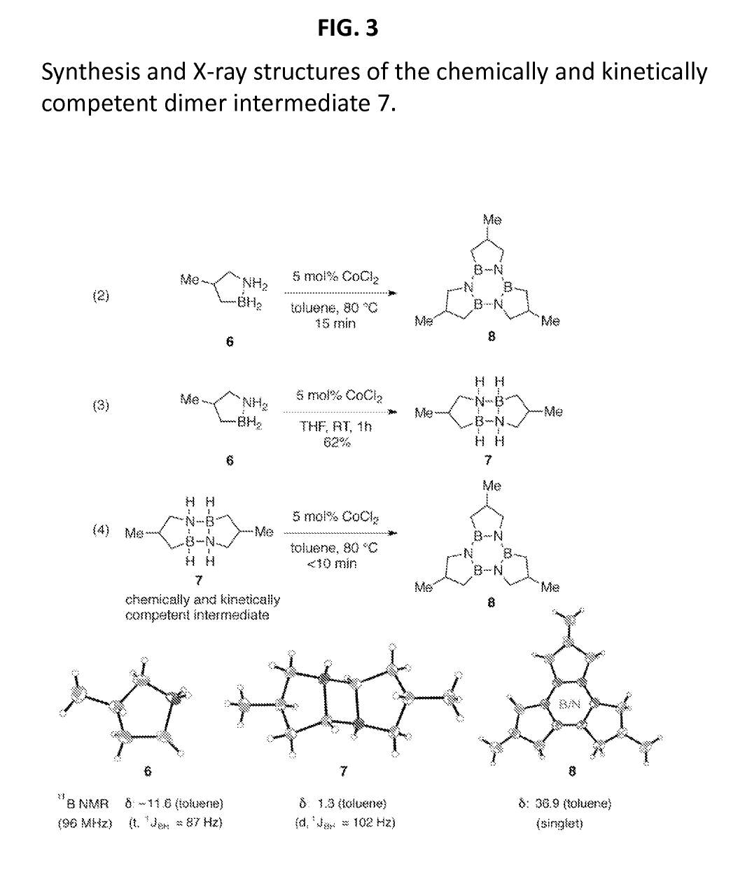

The mechanism of hydrogen release from AB and its derivatives has been studied extensively. Shaw et al. proposed the formation of a 4-membered cyclic dimer as an intermediate in the irreversible H₂ loss from AB on the basis of kinetic and spectroscopic evidence, however this intermediate has not been isolated for the parent H₃N—BH₃ due to its high reactivity. Manners and coworkers were able to isolate the presumed 4-membered BN heterocycle dimer in the dehydrogenation of amine boranes R₂HN—BH₃ in which the R groups on nitrogen (R=alkyl) prevents the dimer from further reactivity. For the liquid-phase material 1, the intermediate dimer 5 (Table 1) similarly could not be isolated. However, the isomeric model compound 6, in which the exocyclic methyl group is β to boron, exhibits crystallinity conducive to potential isolation of reactive intermediates (FIG. 3). By subjecting 6 to 5 mol % CoCl₂ in THF for 1 hour at room temperature the dimeric intermediate 7 was isolated and X-ray quality single crystals for analysis (FIG. 3, eq 3) were grown. When intermediate 7 was subjected to the typical H₂ desorption conditions (eq 4), it cleanly converted to the spent fuel trimer 8 in a timeframe that is similar to the conversion of the monomer fuel 6 to the spent fuel 8 (FIG. 3, eq 4 vs. eq 2). This demonstrates that the intercepted dimer 7 is a chemically and kinetically competent intermediate for the H₂ desorption of the monomeric 6 to its spent fuel 8. On the basis of this crystallographic evidence and the corresponding ¹¹B NMR characterization, it is presently proposed that the dehydrogenation of 1 proceeds via the initial formation of the cyclic BN dimer 5 en route to the trimeric species 2.

Recyclability is critical to the success of any hydrogen storage system. For H₂ desorption of AB, a variety of monomeric (e.g. cyclotriborazene, cyclopentaborazane and borazine) and polymeric (e.g., polyamino- and iminoboranes and polyborazylene) spent fuel products can be produced depending on dehydrogenation conditions, thus making this system less well-defined and arguably potentially more challenging to regenerate. Recently, Sutton and Gordon elegantly demonstrated that one spent fuel product of AB dehydrogenation, polyborazylene, can be regenerated with hydrazine in liquid ammonia. The hydrogen desorption of storage material 1 to form 2 is a clean process. The well-defined molecular nature of the spent fuel product 2 should facilitate the development of a regeneration process. It was determined that when 2 is treated with methanol for 12 hours at room temperature the bismethoxy species 9 is produced, which was confirmed by single crystal X-ray diffraction analysis (Scheme VIII). Subsequent treatment of 9 with LiAlH₄ afforded back the charged fuel 1 in 92% overall yield. This “regeneration” sequence was performed using the product of our 10 mmol scale dehydrogenation experiment (from FIG. 2) to demonstrate the recyclability of our hydrogen storage system on a larger scale.

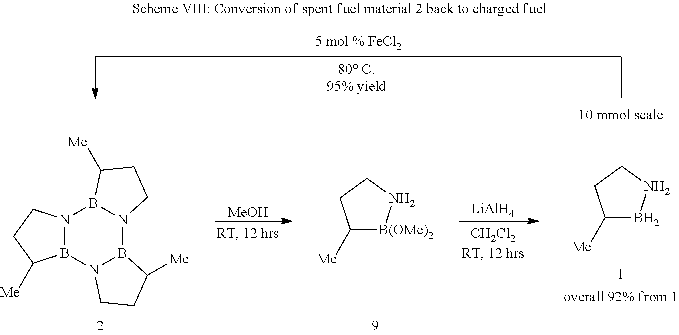

In summary, an air and moisture stable, liquid-phase hydrogen storage material 1 was developed that does not undergo a phase change upon H₂ desorption. A series of first-row transition metal-halide catalysts were discovered that are capable of releasing 2 equivalents of H₂ from 1 in less than 30 minutes in toluene at 80° C. at modest catalyst loadings. It was demonstrated that 1 can quantitatively release H₂ as a neat liquid in the presence of the cheap and abundant FeCl₂ catalyst. Furthermore, it was shown that the spent fuel material 2 can be converted back to the charged fuel 1 in good yield. Preliminary mechanistic studies are consistent with the 4-membered BN heterocyclic dimer being a chemically and kinetically competent intermediate for the H₂ desorption process. The availability of a single-component liquid-phase H₂ storage material at ambient conditions (20° C., 1 atm) that 1) has reasonable H₂ storage capacities, 2) has the potential to take advantage of the existing wide-spread liquid-based fuel distribution infrastructure, 3) releases H₂ controllably using cheap and abundant first-row transition metal halide catalysts at standard PEM fuel cell “waste heat” temperature of 80° C., and that 4) does not exhibit a phase change upon H₂ desorption could represent a viable H₂ storage option for mobile and carrier applications.

The 4-methyl analog (compound 6) was synthesized as described below.

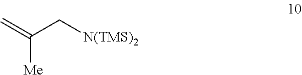

[CAS #89333-65-3] Compound 10. A solution of sodium bis(trimethylsilyl)amide (1.9 M in THF, 53.0 mL, 101 mmol) was added to a solution of 3-bromo-2-methyl propene (10.0 mL, 100 mmol) and sodium iodide (0.030 g, 0.20 mmol) in 100 mL Et₂O at 0° C. The mixture was allowed to warm to room temperature over 0.5 hrs, then refluxed for 12 hours. At the conclusion of the reaction, the reaction was filtered through a glass frit, and the filtrate is concentrated under reduced pressure. The crude material was purified by distillation (bp: 35° C., 1 torr) to afford the desired product 10 as a colorless liquid (12.9 g, 60%). ¹H NMR (300 MHz, C₆D₆): δ 4.99 (d, J=70.5 Hz, 2H), 3.20 (s, 2H), 1.51 (s, 3H), 0.16 (s, 18H).

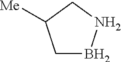

Compound 6. Compound 6 was prepared using the same procedure as compound 1, with the use of 10 instead of 3 as starting material. After purification on a silica column, the desired product, 6, was obtained as a white solid in 90% yield. mp: 50-51° C. X-ray quality crystals were grown from a concentrated Et₂O solution. ¹H NMR (600 MHz, C₆D₆): δ 2.46 (br, 4H), 2.03 (m, 1H), 1.78 (m, 1H), 1.53 (m, 1H), 1.29 (m, 1H), 0.94 (d, J=6.6 Hz, 3H), 0.62 (m, 1H). ¹³C NMR (150 MHz, C₆D₆): δ 52.1, 34.4, 23.6 (br), 19.9. ¹¹B NMR (96 MHz, C₆D₆): δ −8.9 (t, ¹J_{BH}=95 Hz). HRMS (EI) calcd. for C₄H₁₁NB (M-H)⁺ 84.0985. found 84.0983.

In view of the many possible embodiments to which the principles of the disclosed compounds, compositions, and methods may be applied, it should be recognized that the illustrated embodiments are only preferred examples and should not be taken as limiting the scope of the invention.

1. A compound having a structure represented by: 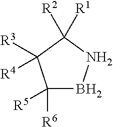
wherein each of R¹ to R⁶ is individually selected from a C₁-C₆ alkyl or H; provided that each of R¹ to R⁶ is H, or at least one of R¹ to R⁶ is methyl.

2. The compound of claim 1, wherein the compound is selected from:

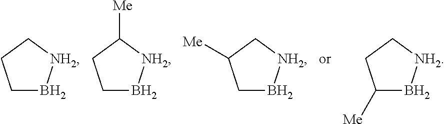

3. The compound of claim 1, wherein at least one of R¹ to R⁶ is methyl.

4. The compound of claim 1, wherein only one of R¹ to R⁶ is a C₁-C₆ alkyl.

5. The compound claim 1, wherein only one of R¹ to R⁶ is methyl.

6. A compound having a structure represented by: 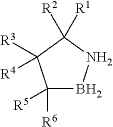
wherein each of R¹ to R⁶ is individually selected from H, a C₁-C₆ alkyl, halogen, a C₁-C₆ alkoxy, a C₁-C₆ alkoxy-substituted C₁-C₆ alkyl, or an amino; provided that neither R⁵ nor R⁶ is an ethyl.

7. The compound of claim 6, wherein each of R¹ to R⁶ is individually selected from H, or a C₁-C₆ alkyl.

8. The compound of claim 1, wherein the compound has a melting point of less than 35° C. at 1 atmosphere.

9. The compound of claim 1, wherein the compound is a liquid at a temperature of 20° C. at 1 atmosphere.

10. The compound of claim 1, wherein the compound has a gravimetric density of at least 4.0 wt % and a volumetric density of at least 35 g H₂/L.

11. A compound having a structure represented by: 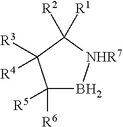
wherein each of R¹ to R⁶ is individually selected from H, a C₁-C₆ alkyl, halogen, a C₁-C₆ alkoxy, a C₁-C₆ alkoxy-substituted C₁-C₆ alkyl, or an amino; and R⁷ is halogen, a C₁-C₆ alkyl C₁-C₆ acyl, SiR⁸₃ wherein R⁸ is halogen, amino or alkoxy.

12. A method comprising reacting an N-protected, optionally-substituted allylamine with triethylamine borane to produce a N-substituted, optionally-carbon-substituted boron-nitrogen cyclopentane intermediate that is subsequently deprotected and hydrogenated to produce an optionally-carbon-substituted boron-nitrogen cyclopentane.

13. The method of claim 12, wherein the N-protected, optionally-substituted allylamine has a structure of (R¹⁰)C═C(R⁹)—CH(R⁸)—N(trimethylsilyl)₂.

14. A hydrogen storage system comprising a compound having a structure represented by: 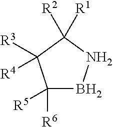
wherein each of R¹ to R⁶ is individually selected from a C₁-C₆ alkyl or H.

15. The hydrogen storage system of claim 14, wherein the compound is:

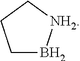

16. The hydrogen storage system of claim 14, wherein at least one of R¹-R⁶ is methyl.

17. The hydrogen storage system of claim 14, wherein only one of R¹ to R⁶ is a C₁-C₆ alkyl.

18. The hydrogen storage system of claim 14, wherein the compound is selected from:

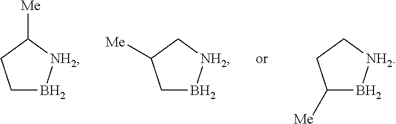

19. A hydrogen storage system comprising a compound of claim 6.

20. The hydrogen storage system of claim 14, wherein the hydrogen storage system is a liquid.

21. The hydrogen storage system of claim 14, wherein the system comprises a composition that is a liquid at a temperature of 20° C. at 1 atmosphere.

22. The hydrogen storage system of claim 14, wherein the system further comprises at least one additional additive.

23. The hydrogen storage system of claim 22, wherein the at least one addition additive comprises an additional hydrogen fuel additive.

24. The hydrogen storage system of claim 23, wherein the additional hydrogen fuel additive comprises ammonia borane, methylamine borane, R²⁰NH₂—BH₂R²¹ wherein R²⁰ and R²¹ are each individually a C₁-C₆ alkyl, or a mixture thereof.

25. The hydrogen storage system of claim 14, wherein the system further comprises at least one boron-nitrogen trimeric fused heterocycle.

26. The hydrogen storage system of claim 25, wherein the at least one boron-nitrogen trimeric fused heterocycle has a structure represented by: 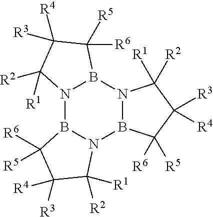
wherein each of R¹ to R⁶ is individually selected from H, a C₁-C₆ alkyl, halogen, a C₁-C₆ alkoxy, a C₁-C₆ alkoxy-substituted C₁-C₆ alkyl, or an amino.

27. A method comprising releasing hydrogen from the compound of claim 1.

28. A method comprising releasing hydrogen from the compound of claim 5.

29. The method of claim 27, wherein releasing hydrogen comprises releasing one or more equivalents of dihydrogen from the compound of claim 1.

30. The method of claim 28, wherein releasing hydrogen comprises releasing one or more equivalents of dihydrogen from the compound of claim 1.

31. The method of claim 27, wherein releasing hydrogen comprises producing at least one boron-nitrogen trimeric fused heterocycle.

32. The method of claim 28, wherein releasing hydrogen comprises producing at least one boron-nitrogen trimeric fused heterocycle.

33. The method of claim 31, wherein releasing hydrogen comprises producing a compound having a structure represented by:

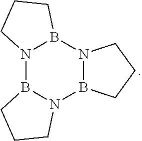 [SMILES: C1CB2N(C1)B1CCCN1B1CCCN21]

34. The method of claim 31, wherein at least one boron-nitrogen trimeric fused heterocycle has a structure represented by: 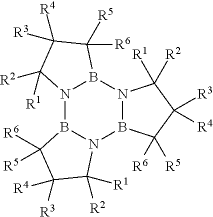
wherein each of R¹ to R⁶ is individually selected from H, a C₁-C₆ alkyl, halogen, a C₁-C₆ alkoxy, a C₁-C₆ alkoxy-substituted C₁-C₆ alkyl, or an amino.

35. The method of claim 27, wherein heating of the compound of releases hydrogen.

36. The method of claim 27, wherein releasing hydrogen comprises contacting the compound with a catalyst.

37. The method of claim 36, wherein the catalyst comprises a metal halide catalyst.

38. The method of claim 37, wherein the catalyst is FeCl₂.

39. The method of claim 31, further comprising hydrogenating the boron-nitrogen trimeric fused heterocycle.

40. The method of claim 32, further comprising hydrogenating the boron-nitrogen trimeric fused heterocycle.

41. The method of claim 39, wherein the hydrogenating comprises subjecting the boron-nitrogen trimeric fused heterocycle to alkanolysis to produce an intermediate and then reducing the intermediate.

42. The method of claim 39, wherein the hydrogenating comprises treating the boron-nitrogen trimeric fused heterocycle with formic acid.

43. A method comprising:
releasing hydrogen from a compound having a structure represented by: 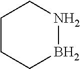
under conditions sufficient to produce at least one boron-nitrogen trimer heterocycle; and
hydrogenating the boron-nitrogen trimeric fused heterocycle.

44. A hydrogen storage method comprising:
releasing hydrogen from at least one saturated boron-nitrogen monocyclic heterocycle under conditions sufficient to produce at least one boron-nitrogen trimeric fused heterocycle;
and hydrogenating the boron-nitrogen trimeric fused heterocycle.

45. The method of claim 44, wherein the at least one saturated boron-nitrogen monocyclic heterocycle has a structure represented by: 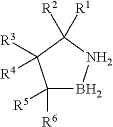
wherein each of R¹ to R⁶ is individually selected from a C₁-C₆ alkyl or H; provided that each of R¹ to R⁶ is H, or at least one of R¹ to R⁶ is methyl.
